(19) United States
(12) Patent Application Publication
(10) Pub. No.: US 2026/0018782 A1
(43) Pub. Date: Jan. 15, 2026

(54) WEARABLE DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW); Chien-Chih CHEN, Taoyuan City (TW)

(73) Assignee: HTC Corporation, Taoyuan City (TW)

(21) Appl. No.: 19/229,352

(22) Filed: Jun. 5, 2025

Related U.S. Application Data
(60) Provisional application No. 63/668,968, filed on Jul. 9, 2024.

(30) Foreign Application Priority Data
Apr. 23, 2025 (TW) 114115275

(51) Int. Cl. H01Q 1/27; H01Q 1/48; H01Q 1/52; H01Q 5/20

(52) U.S. Cl. CPC H01Q 1/273; H01Q 1/48; H01Q 1/521; H01Q 5/20

(57) ABSTRACT

A wearable device includes a frame element, an extension element, a ground element, a first antenna element, a second antenna element, and a first decoupler. The extension element is connected to the frame element. The ground element is attached to the extension element. The first antenna element is adjacent to the ground element. The second antenna element is adjacent to the ground element. The first decoupler is disposed between the first antenna element and the second antenna element. The first decoupler is configured to enhance the isolation between the first antenna element and the second antenna element.

### CROSS REFERENCE TO RELATED APPLICATIONS

This application claims the benefit of U.S. Provisional Application No. 63/668,968, filed on Jul. 9, 2024, and also claims priority of Taiwan Patent Application No. 114115275, filed on Apr. 23, 2025, the entirety of which are incorporated by reference herein.

### BACKGROUND OF THE INVENTION

### Field of the Invention

The invention relates to a wearable device, and more particularly, it relates to a wearable device and a communication method thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. However, if the isolation between multiple antennas is not enough, it may degrade the communication quality of the related mobile device. Accordingly, there is a need to propose a novel solution for solving the problem of the prior art.

### BRIEF SUMMARY OF THE INVENTION

In an exemplary embodiment, the invention is directed to a wearable device that includes a frame element, an extension element, a ground element, a first antenna element, a second antenna element, and a first decoupler. The extension element is connected to the frame element. The ground element is attached to the extension element. The first antenna element is adjacent to the ground element. The second antenna element is adjacent to the ground element. The first decoupler is disposed between the first antenna element and the second antenna element. The first decoupler is configured to enhance the isolation between the first antenna element and the second antenna element.

In some embodiments, the wearable device is a pair of smart eyeglasses with the function of wireless communication.

In some embodiments, the frame element is a glasses frame.

In some embodiments, the extension element is a temple.

In some embodiments, both the first antenna element and the second antenna element cover a low frequency band and a high frequency band.

In some embodiments, the low frequency band is from 700 MHz to 2500 MHz, and the high frequency band is from 5150 MHz to 7125 MHz.

In some embodiments, the length of the ground element is from 0.5 to 1 wavelength of the low frequency band.

In some embodiments, the distance between the first antenna element and the second antenna element is shorter than or equal to 0.1 wavelength of the low frequency band.

In some embodiments, the first antenna element includes a first radiation element.

In some embodiments, the length of the first radiation element is from 0.25 to 0.5 wavelength of the low frequency band.

In some embodiments, the second antenna element includes a second radiation element.

In some embodiments, the length of the second radiation element is from 0.25 to 0.5 wavelength of the low frequency band.

In some embodiments, the first decoupler includes a metal strip. The vertical projection of the metal strip at least partially overlaps both the first radiation element and the second radiation element.

In some embodiments, the first decoupler includes a variable inductor. The variable inductor is coupled between the first radiation element and the second radiation element.

In some embodiments, the first decoupler includes a variable capacitor. The variable capacitor is coupled between the first radiation element and the second radiation element.

In some embodiments, a first coupling gap is formed between the first radiation element and the ground element, and a second coupling gap is formed between the second radiation element and the ground element. The width of each of the first coupling gap and the second coupling gap is shorter than or equal to 0.1 wavelength of the low frequency band.

In some embodiments, the wearable device further includes a third antenna element and a second decoupler. The third antenna element is disposed adjacent to the ground element. The second decoupler is disposed between the second antenna element and the third antenna element. The second decoupler is configured to enhance the isolation between the second antenna element and the third antenna element.

In some embodiments, the third antenna element includes a third radiation element.

In some embodiments, the length of the third radiation element is from 0.25 to 0.5 wavelength of the low frequency band.

In another exemplary embodiment, the invention is directed to a communication method that includes the steps of: providing a frame element, an extension element, a ground element, a first antenna element, and a second antenna element, wherein the extension element is connected to the frame element, the ground element is attached to the extension element, and both the first antenna element and the second antenna element are adjacent to the ground element; disposing a first decoupler between the first antenna element and the second antenna element; and using the first decoupler to enhance the isolation between the first antenna element and the second antenna element.

### BRIEF DESCRIPTION OF DRAWINGS

The invention can be more fully understood by reading the subsequent detailed description and examples with references made to the accompanying drawings, wherein:

FIG. 1 is a diagram of a wearable device according to an embodiment of the invention;

FIG. 2 is a diagram of a wearable device according to an embodiment of the invention;

FIG. 3 is a diagram of a wearable device according to an embodiment of the invention;

FIG. 4 is a diagram of a wearable device according to an embodiment of the invention;

FIG. 5 is a diagram of a wearable device according to an embodiment of the invention; and

FIG. 6 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

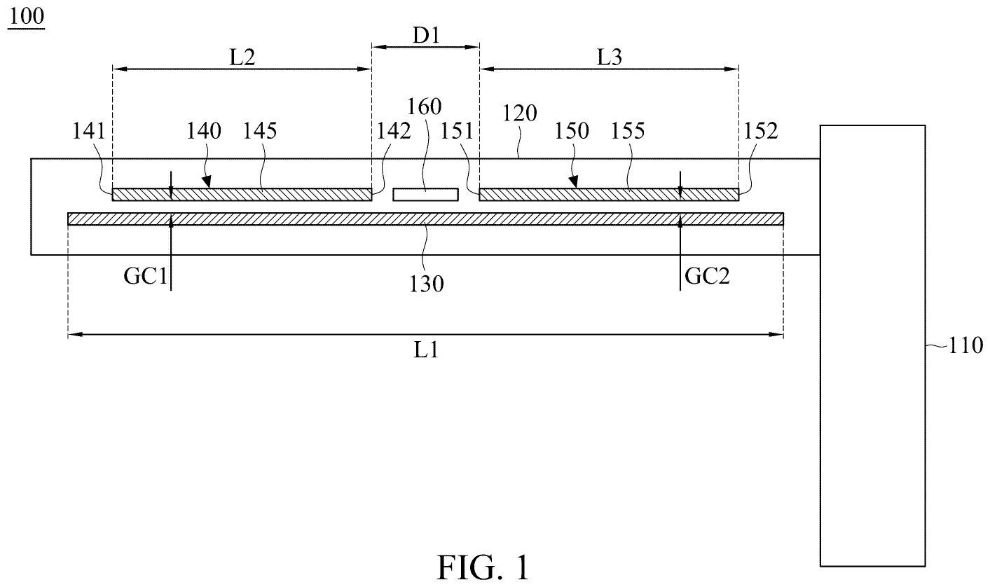

FIG. 1 is a diagram of a wearable device 100 according to an embodiment of the invention. For example, the wearable device 100 may be applied to the field of VR (Virtual Reality) or AR (Augmented Reality), but it is not limited thereto. As shown in FIG. 1, the wearable device 100 includes a frame element 110, an extension element 120, a ground element 130, a first antenna element 140, a second antenna element 150, and a first decoupler 160. The ground element 130, the first antenna element 140, and the second antenna element 150 may all be made of metal materials, such as copper, silver, aluminum, iron or their alloys. It should be understood that the wearable device 100 may include other components, such as a transmission line, an electrode, a battery, and/or a power supply module, although they are not displayed in FIG. 1.

The shapes and the styles of the frame element 110 and the extension element 120 are not limited in the invention. The extension element 120 is connected to the frame element 110. The user can easily wear the wearable device 100 by using the frame element 110 and the extension element 120. In some embodiments, the frame element 110 and the extension element 120 are made of nonconductive materials, such as plastic materials.

The ground element 130 is attached to the extension element 120. For example, the ground element 130 may substantially have a long straight-line shape, and the width of the ground element 130 may be smaller than 10 mm. In addition, the ground element 130 may be coupled to a system ground plane (not shown). In some embodiments, the ground element 130 is disposed on any surface of the extension element 120. However, the invention is not limited thereto. In alternative embodiments, the ground element 130 is embedded in the extension element 120.

The first antenna element 140 is adjacent to the ground element 130. The first antenna element 140 includes a first radiation element 145. For example, the first radiation element 145 may substantially have a short straight-line shape, which may be substantially parallel to the ground element 130. Specifically, the first radiation element 145 has a first end 141 and a second end 142, each of which is an open end. In some embodiments, a first coupling gap GC1 is formed between the first radiation element 145 and the ground element 130. It should also be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0).

The second antenna element 150 is adjacent to the ground element 130. The second antenna element 150 includes a second radiation element 155. For example, the second radiation element 155 may substantially have another short straight-line shape, which may be substantially parallel to the ground element 130. Specifically, the second radiation element 155 has a first end 151 and a second end 152, each of which is an open end. In some embodiments, a second coupling gap GC2 is formed between the second radiation element 155 and the ground element 130.

In some embodiments, the wearable device 100 further includes a first signal source and a second signal source (not shown), each of which may be an RF (Radio Frequency) module. Specifically, the first signal source is coupled to any position on the first radiation element 145, so as to excite the first antenna element 140. Also, the second signal source is coupled to any position on the second radiation element 155, so as to excite the second antenna element 150. In alternative embodiments, adjustments are made so that any of the first radiation element 145 and the second radiation element 155 has a meandering shape, such an L-shape, a C-shape or a W-shape, but it is not limited thereto.

The first decoupler 160 is disposed between the first antenna element 140 and the second antenna element 150. For example, the first decoupler 160 may be implemented with a metal element or a reactance element. Similarly, the first decoupler 160 and the first radiation element 145 and the second radiation element 155 as mentioned above may be disposed on any surface of the extension element 120, or may be embedded in the extension element 120, but they are not limited thereto. It should be noted that the first decoupler 160 is configured to enhance the isolation between the first antenna element 140 and the second antenna element 150. In alternative embodiments, an external surface of the first decoupler 160 is used as an appearance element of the wearable device 100, and it has the function of capacitive sensing controllers. Furthermore, when any finger of a user touches the external surface of the first decoupler 160, the first decoupler 160 may perform a movement detection and switching process.

In some embodiments, both the first antenna element 140 and the second antenna element 150 of the wearable device 100 can cover a low frequency band and a high frequency band. For example, the low frequency band may be from 700 MHz to 2500 MHz, and the high frequency band may be from 5150 MHz to 7125 MHz. Thus, the wearable device 100 can support at least the wideband operations of WLAN (Wireless Local Area Network), Wi-Fi 6E, and Wi-Fi 7. However, the invention is not limited thereto. In alternative embodiments, the low frequency band and the high frequency band are adjustable, such that the wearable device 100 can also support the wideband operations of WWAN (Wireless Wide Area Network).

With the design of the invention, the ground element 130, the first antenna element 140, the second antenna element 150, and the first decoupler 160 can be well integrated with the frame element 110 and the extension element 120 of the wearable device 100. In addition, the first decoupler 160 can further reduce the distance D1 between the first antenna element 140 and the second antenna element 150. Therefore, the proposed wearable device 100 of the invention can cover the desired wideband operations and provide the function of MIMO (Multi-Input and Multi-Output), without additionally increasing its overall size.

In some embodiments, the element sizes of the wearable device 100 will be described as follows. The length L1 of the ground element 130 may be from 0.5 to 1 wavelength (λ/2˜λ2) of the low frequency band of the first antenna element 140 and the second antenna element 150 of the wearable device 100. The distance D1 between the first antenna element 140 and the second antenna element 150 may be shorter than or equal to 0.1 wavelength (λ/10) of the low frequency band of the first antenna element 140 and the second antenna element 150 of the wearable device 100. The length L2 of the first radiation element 145 may be from 0.25 to 0.5 wavelength (λ/4˜λ/2) of the low frequency band of the first antenna element 140 and the second antenna element 150 of the wearable device 100. The length L3 of the second radiation element 155 may be from 0.25 to 0.5 wavelength (λ/4˜λ/2) of the low frequency band of the first antenna element 140 and the second antenna element 150 of the wearable device 100. The width of the first coupling gap GC1 may be shorter than or equal to 0.1 wavelength (λ/10) of the low frequency band of the first antenna element 140 and the second antenna element 150 of the wearable device 100. The width of the second coupling gap GC2 may be shorter than or equal to 0.1 wavelength (λ/10) of the low frequency band of the first antenna element 140 and the second antenna element 150 of the wearable device 100. The above ranges of element sizes are calculated and obtained according to many experiment results, and they help to optimize the antenna isolation, the operational bandwidth, and the impedance matching of the wearable device 100.

The following embodiments will introduce different configurations and detail structural features of the wearable device 100. It should be understood that these figures and descriptions are merely exemplary, rather than limitations of the invention.

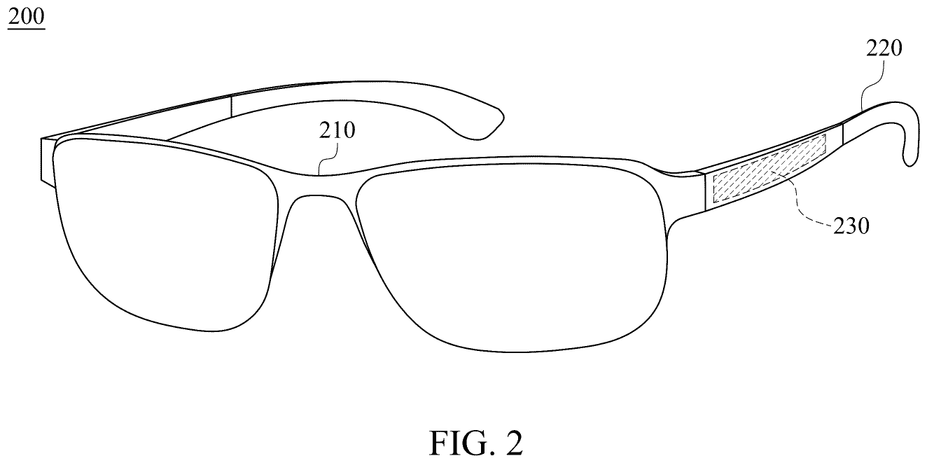

FIG. 2 is a diagram of a wearable device 200 according to an embodiment of the invention. FIG. 2 is similar to FIG. 1. In the embodiment of FIG. 2, the wearable device 200 is a pair of smart eyeglasses with the function of wireless communication. Specifically, the wearable device 200 at least includes a frame element 210, an extension element 220, and a ground element 230. The ground element 230 is embedded in the extension element 220. For example, the frame element 210 may be a glasses frame, and the extension element 220 may be a temple. Other features of the wearable device 200 of FIG. 2 are similar to those of the wearable device 100 of FIG. 1. Accordingly, the two embodiments can achieve similar levels of performance.

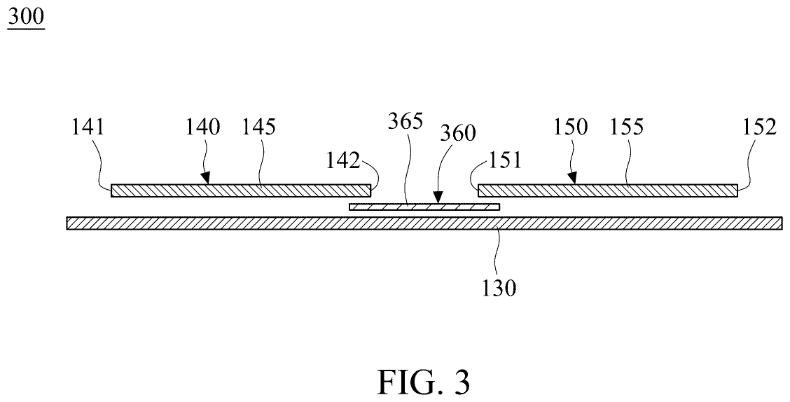

FIG. 3 is a diagram of a wearable device 300 according to an embodiment of the invention. FIG. 3 is similar to FIG. 1. In the embodiment of FIG. 3, a first decoupler 360 of the wearable device 300 includes a metal strip 365 disposed between the ground element 130 and the first antenna element 140 or the second antenna element 150. For example, the metal strip 365 may be floating. Alternatively, the metal strip 365 may be coupled to the ground element 130. With respect to the normal direction of the ground element 130, the vertical projection of the metal strip 365 may at least partially overlap the second end 142 of the first radiation element 145 and the first end 151 of the second radiation element 155. In alternative embodiments, the metal strip 365 is positioned above the first radiation element 145 and the second radiation element 155. Other features of the wearable device 300 of FIG. 3 are similar to those of the wearable device 100 of FIG. 1. Accordingly, the two embodiments can achieve similar levels of performance.

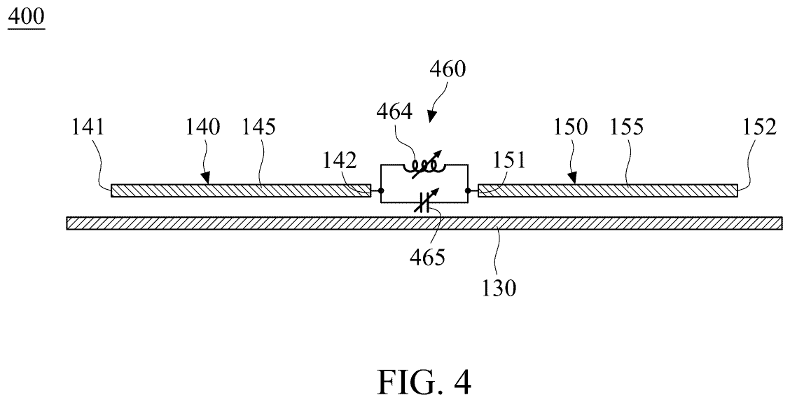

FIG. 4 is a diagram of a wearable device 400 according to an embodiment of the invention. FIG. 4 is similar to FIG. 1. In the embodiment of FIG. 4, a first decoupler 460 of the wearable device 400 includes a variable inductor 464 and a variable capacitor 465. The variable inductor 464 is coupled between the second end 142 of the first radiation element 145 and the first end 151 of the second radiation element 155. For example, the inductance of the variable inductor 464 may be from 0.1 nH to 10 nH. The variable capacitor 465 is coupled between the second end 142 of the first radiation element 145 and the first end 151 of the second radiation element 155. For example, the capacitance of the variable capacitor 465 may be from 0.1 pF to 10 pF. In alternative embodiments, the first decoupler 460 merely includes either the variable inductor 464 or the variable capacitor 465. Other features of the wearable device 400 of FIG. 4 are similar to those of the wearable device 100 of FIG. 1. Accordingly, the two embodiments can achieve similar levels of performance.

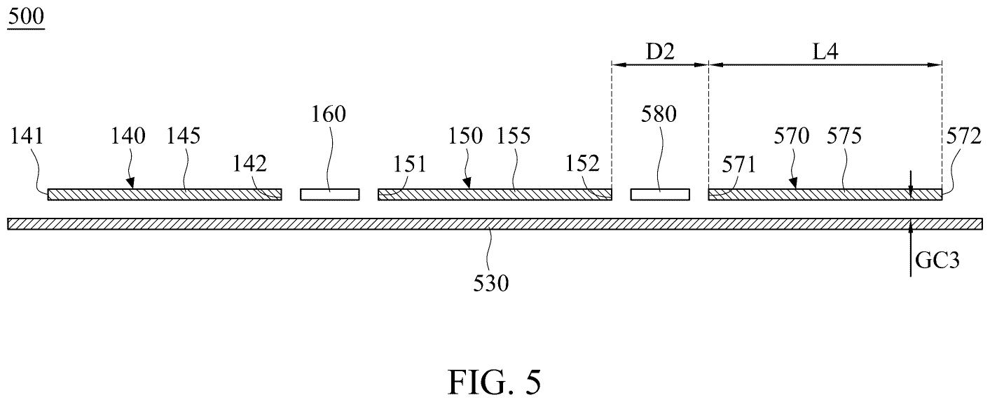

FIG. 5 is a diagram of a wearable device 500 according to an embodiment of the invention. FIG. 5 is similar to FIG. 1. In the embodiment of FIG. 5, the wearable device 500 further includes a third antenna element 570 and a second decoupler 580, and a ground element 530 of the wearable device 500 also becomes longer. The third antenna element 570 is adjacent to the ground element 530. The third antenna element 570 includes a third radiation element 575. For example, the third radiation element 575 may substantially have another short straight-line shape, which may be substantially parallel to the ground element 530. Specifically, the third radiation element 575 has a first end 571 and a second end 572, each of which is an open end. A third coupling gap GC3 may be formed between the third radiation element 575 and the ground element 530. The second decoupler 580 is disposed between the second antenna element 150 and the third antenna element 570. The second decoupler 580 is configured to enhance the isolation between the second antenna element 150 and the third antenna element 570. With the element sizes, the length L4 of the third radiation element 575 may be from 0.25 to 0.5 wavelength (λ/4˜λ/2) of the low frequency band of the first antenna element 140, the second antenna element 150 and the third antenna element 570 of the wearable device 500. The distance D2 between the second antenna element 150 and the third antenna element 570 may be shorter than or equal to 0.1 wavelength (λ/10) of the low frequency band of the first antenna element 140, the second antenna element 150 and the third antenna element 570 of the wearable device 500. In addition, the width of the third coupling gap GC3 may be shorter than or equal to 0.1 wavelength (λ/10) of the low frequency band of the first antenna element 140, the second antenna element 150, and the third antenna element 570 of the wearable device 500. In other embodiments, the wearable device 500 further includes more antenna elements and more decouplers. Other features of the wearable device 500 of FIG. 5 are similar to those of the wearable device 100 of FIG. 1. Accordingly, the two embodiments can achieve similar levels of performance.

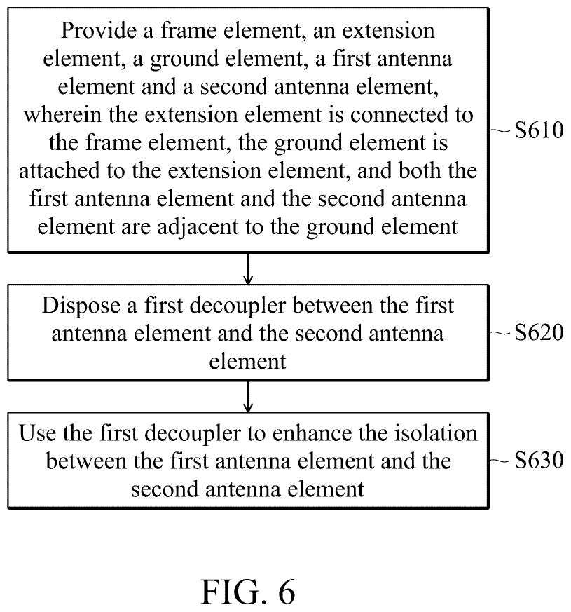

FIG. 6 is a flowchart of a communication method according to an embodiment of the invention. To begin, in step S610, a frame element, an extension element, a ground element, a first antenna element, and a second antenna element are provided. The extension element is connected to the frame element. The ground element is attached to the extension element. Both the first antenna element and the second antenna element are adjacent to the ground element. In step S620, a first decoupler is disposed between the first antenna element and the second antenna element. Finally, in step S630, the first decoupler is used to enhance the isolation between the first antenna element and the second antenna element. It should be understood that these steps are not required to be performed in order, and every feature of the embodiments of FIGS. 1-5 may be applied to the communication method of FIG. 6.

The invention proposes a novel wearable device. According to practical measurements, the wearable device using the above design can significantly improve its antenna isolation and its overall communication quality. Therefore, the invention is suitable for application in a variety of equipment.

Note that the above element sizes, element shapes, and element parameters are not limitations of the invention. A designer can fine-tune these setting values according to different requirements. It should be understood that the wearable device and the communication method of the invention are not limited to the configurations of FIGS. 1-6. The invention may include any one or more features of any one or more embodiments of FIGS. 1-6. In other words, not all of the features displayed in the figures should be implemented in the wearable device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device, comprising:
a frame element;
an extension element, connected to the frame element;
a ground element, attached to the extension element;
a first antenna element, disposed adjacent to the ground element;
a second antenna element, disposed adjacent to the ground element; and
a first decoupler, disposed between the first antenna element and the second antenna element;
wherein the first decoupler is configured to enhance isolation between the first antenna element and the second antenna element.

2. The wearable device as claimed in claim 1, wherein the wearable device is a pair of smart eyeglasses with a function of wireless communication.

3. The wearable device as claimed in claim 1, wherein the frame element is a glasses frame.

4. The wearable device as claimed in claim 1, wherein the extension element is a temple.

5. The wearable device as claimed in claim 1, wherein both the first antenna element and the second antenna element cover a low frequency band and a high frequency band.

6. The wearable device as claimed in claim 5, wherein the low frequency band is from 700 MHz to 2500 MHz, and the high frequency band is from 5150 MHz to 7125 MHz.

7. The wearable device as claimed in claim 5, wherein a length of the ground element is from 0.5 to 1 wavelength of the low frequency band.

8. The wearable device as claimed in claim 5, wherein a distance between the first antenna element and the second antenna element is shorter than or equal to 0.1 wavelength of the low frequency band.

9. The wearable device as claimed in claim 5, wherein the first antenna element comprises a first radiation element.

10. The wearable device as claimed in claim 9, wherein a length of the first radiation element is from 0.25 to 0.5 wavelength of the low frequency band.

11. The wearable device as claimed in claim 9, wherein the second antenna element comprises a second radiation element.

12. The wearable device as claimed in claim 11, wherein a length of the second radiation element is from 0.25 to 0.5 wavelength of the low frequency band.

13. The wearable device as claimed in claim 11, wherein the first decoupler comprises a metal strip, and a vertical projection of the metal strip at least partially overlaps both the first radiation element and the second radiation element.

14. The wearable device as claimed in claim 11, wherein the first decoupler comprises a variable inductor, and the variable inductor is coupled between the first radiation element and the second radiation element.

15. The wearable device as claimed in claim 11, wherein the first decoupler comprises a variable capacitor, and the variable capacitor is coupled between the first radiation element and the second radiation element.

16. The wearable device as claimed in claim 11, wherein a first coupling gap is formed between the first radiation element and the ground element, a second coupling gap is formed between the second radiation element and the ground element, and a width of each of the first coupling gap and the second coupling gap is shorter than or equal to 0.1 wavelength of the low frequency band.

17. The wearable device as claimed in claim 5, further comprising:
a third antenna element, disposed adjacent to the ground element; and
a second decoupler, disposed between the second antenna element and the third antenna element;
wherein the second decoupler is configured to enhance isolation between the second antenna element and the third antenna element.

18. The wearable device as claimed in claim 17, wherein the third antenna element comprises a third radiation element.

19. The wearable device as claimed in claim 18, wherein a length of the third radiation element is from 0.25 to 0.5 wavelength of the low frequency band.

20. A communication method, comprising the steps of:
providing a frame element, an extension element, a ground element, a first antenna element, and a second antenna element, wherein the extension element is connected to the frame element, the ground element is attached to the extension element, and both the first antenna element and the second antenna element are adjacent to the ground element;
disposing a first decoupler between the first antenna element and the second antenna element; and
using the first decoupler to enhance isolation between the first antenna element and the second antenna element.
